(19) United States
(12) Patent Application Publication
(10) Pub. No.: US 2022/0178322 A1
(43) Pub. Date: Jun. 9, 2022

(54) METHOD AND COMPUTING UNIT FOR OPERATING A COMBUSTION ENGINE WITH A PARTICLE FILTER

(71) Applicant: Robert Bosch GmbH, Stuttgart (DE)

(72) Inventors: Martin Buchholz, Bietigheim-Bissingen (DE); Arne Huber, Herrenberg (DE)

(21) Appl. No.: 17/540,139

(22) Filed: Dec. 1, 2021

(30) Foreign Application Priority Data
Dec. 3, 2020 (DE) 10 2020 215 291.8

(51) Int. Cl. F02D 41/14; F02D 41/02

(52) U.S. Cl. CPC F02D 41/1444; F02D 41/0235; F02D 2200/06; F02D 2200/70; F02D 2200/021

(57) ABSTRACT

A method (200) for operating a combustion engine (120) with a particle filter (130) is disclosed, wherein an exhaust gas flow of the combustion engine (120) is passed through the particle filter (130), a particle concentration in the exhaust gas flow is measured (220) downstream of the particle filter (130) and the combustion engine is operated at least depending on the measured particle concentration downstream of the particle filter.

### BACKGROUND OF THE INVENTION

The present invention relates to a method for operating a combustion engine, in particular of a vehicle, with a particle filter and a computing unit and a computer program for carrying it out.

In many regions of the world, limit values have already been set for particulate emissions from vehicles with petrol and diesel engines. The underlying operating conditions were successively extended from narrowly defined conditions on the test bench to much more comprehensive tests on the road (Real Driving Emissions RDE). These include, in particular, cold starts and dynamic states with high loads.

For this reason, gasoline particle filters (GPF) are currently being widely introduced. It has turned out that the operation of the GPFs is much more complex than expected. A simple adoption of the findings from the operation of diesel particle filters (DPF), which have been established for many years, has proven to be unsuitable.

The primary task of the particle filter is to rid the exhaust gases of solid particles as completely as possible. This function is described with the filter efficiency which in particular strongly depends on the particle size and the loading state of the filter. The filter efficiency is usually higher the more loading there is in the filter because the exhaust gas must flow through the already existing filter cake in the filter. The filter cake itself acts as a filter for the exhaust gas and significantly increases the effectiveness of the filter.

A number of physical mechanisms are relevant for the filtration effect, such as sedimentation. The effectiveness of these mechanisms, in turn, depends on the particle size. Overall, the filter efficiency is therefore strongly dependent on the particle size and thus overall on the particle size distribution.

As a rule, very small particles are well separated in the filter due to their high mobility. The same applies to comparatively large particles, which are also well separated locally in the filter due to their inertia when the flow direction changes. On the other hand, the filtration efficiency is worse in the medium size range because both mechanisms mentioned are less effective for the separation of particles in this size range.

The particle size spectrum of petrol engines as well as the particle concentration depend on a variety of parameters, such as the engine temperature, the load condition as well as the fuel composition or the engine application or adjustment parameters. In addition, there are influences due to aging and component defects in the engine. As a rule, the particulate emissions in the petrol engine, which are significant in terms of particle number concentration PN, are in the size range between 10 nm and 200 nm, with a focus on the range between 40 nm and 80 nm. In the petrol engine, emissions during cold starts can dominate particulate emissions very strongly, especially at very low ambient temperatures.

Under unfavorable conditions, the raw emissions of the engine may be too high or the filtration efficiency of the filter may be too low to comply with legal requirements. An approach to improve this situation is an engine application optimized for the particle number concentration PN and operation of the filter with a comparatively high load. Both parameters lead to a comparatively high fuel consumption or high CO₂ emissions as a result of the selected combustion setting and the high exhaust gas back pressure through the GPF, if the extremely unfavorable conditions used for the design are not present. This is usually true. This results in a large reduction potential in terms of fuel consumption and non-particulate emissions.

When operating the GPF in a vehicle with a petrol engine, passive regeneration of the GPF often occurs—unlike in the diesel system. The primary cause is the usually much higher exhaust gas temperature of the petrol engine. However, the regulation of the petrol-fuel ratio also plays a major role, because without a sufficient content of an oxidizing agent in the exhaust gas (for example oxygen), sufficient burning of the soot in the filter does not take place. Therefore, dynamic and short-term operating states such as overrun mode play an important role in the passive regeneration of the filter. In general, the exact description or modeling of the load state in the filter is very difficult and subject to tolerances, so a loadable quantity for the loading state of the filter is typically not available in the engine control unit. As a consequence, the filtration efficiency in conventional applications is not known. Furthermore, there is a large production scatter and a dependence on aging in the GPF, among other things.

In order to avoid exceeding limits, large safety margins with regard to particulate emissions in the application and system design are therefore required in order to avoid unfavorable combinations (driving behavior, fuel, environmental conditions, . . . ) to comply with the statutory emission limits as far as possible.

In order to safely avoid possible overloading of the filter, additional sensors may be provided in the system, for example a differential pressure sensor on the GPF. On the basis of data collected by these additional sensors, an active regeneration of the filter can be started if necessary. However, the problem in this context is that there is insufficient correlation between the back pressure and the filtration efficiency or the particulate emissions downstream of the GPF. This is especially true if, for example, the accumulation of ash in the filter and possible damage to the GPF are also taken into account. In addition, differential pressure sensors are typically not sensitive enough to detect the loading state of the filter with sufficient sensitivity.

### SUMMARY OF THE INVENTION

According to the invention, a method for operating a combustion engine with a particle filter and a computing unit and a computer program for carrying it out with the features of the independent claims are proposed. Advantageous embodiments are the subject of the subordinate claims as well as the following description.

In the following explanations, the application to the petrol engine is primarily described. However, an application is not limited to the petrol engine. The approaches are largely transferable to the diesel engine. The invention is also applicable to gas engines for example.

The core of the invention is to enable optimal operation of the system for multiple variables (for example particle number concentration PN, particle mass concentration PM, CO₂ emissions) by means of adaptive loading control and regulation of the particle filter. The loading of the particle filter is regulated on the basis of particulate emissions remaining downstream of the particle filter, for example to a range between an upper threshold value and a lower threshold value or to a setpoint (i.e. upper and lower threshold values are equal). In this way, in addition to compliance with the particulate emissions limits, the optimization of emissions is also ensured.

In particular, compliance with the particulate emissions limits can be achieved at the same time as optimally low CO₂ emissions or low fuel consumption.

Due to the optimally low loading condition of the filter, an exhaust gas back pressure on the engine is optimally low. This leads to an improvement in the degree of engine effectiveness and thus also to reduced CO₂ emissions. In addition, the combustion can be adjusted in such a way that only CO₂ is produced as far as possible, so that few harmful exhaust gases are produced.

Overall, optimally low CO₂ emissions are thus achieved while at the same time complying with the legal emission values. Compared with the prior art there is thus a considerable improvement, at least with regard to these two variables.

Intervention paths for influencing the loading state of the particle filter lie in particular in the engine control system by focusing on engine operation towards “GPF regeneration” (for example regulation towards higher oxygen content in the exhaust gas) or “allow loading build-up” (in particular lower oxygen content in the exhaust gas). Possible intervention variables are combustion control (all parameters which influence the particulate emissions (positive and negative influence on the loading)), the regeneration control of the particle filter (active and/or passive (negative influence on the loading)) and, if appropriate, interventions or limiting with regard to the engine characteristics available to the driver (negative influence on the loading), especially in order to reduce load points with very high particulate emissions in the case of highly dynamic load requirements and in cold starts. In addition, the control of passive particle filter regeneration can be intervened in, in particular by not enabling overrun for example. Such an “overrun inhibition” is advantageous to avoid burning or partial burning of the soot cake in the filter.

In principle, the diesel engine also has other influencing variables. Besides a temporary limiting intervention on the engine map or a temporary limitation of the dynamics, in particular a shift of the engine operating point on the NOₓ particulate emissions hyperbola comes into question.

The loading state of the filter consequently represents a dynamically changeable variable, which is set optimally low taking into account a variety of parameters when using the present invention. The parameters are all system and operating parameters influencing the output variables, such as fuel (quality), environment (for example pressure, temperature, composition of the atmosphere), driver behavior, driving profile, system characteristics including scatter of the individual vehicle, ageing and defects.

By measuring an emission-relevant output variable such as the particle number concentration PN (or other measuring factors such as particle mass concentration PM), all influencing variables of the system are directly taken into account and the optimal operating state can thus be set and maintained.

The mentioned particle number concentration describes the concentration of solid particles as the number of particles in relation to a volume of the respective gaseous carrier medium. This results in an inverse volume concentration PN as the dimension of this particle number concentration PN, for example with a unit [PN]=1/m³. The particle mass concentration PM, on the other hand, describes the mass of particles in the corresponding gaseous carrier medium on the basis of the total mass of solid particles in suspension. This results in a mass per volume as a dimension of this particle mass concentration, for example [PM]=1 g/m³ as a unit.

In addition to the operational control of the filter operation, evidence regarding the system status or a diagnosis can also be derived from the determined parameters. This applies, for example to the onboard diagnosis (OBD) of components such as for example the filter and the engine. Evidence as to the extent to which the real vehicle emissions are within the legally prescribed emission limits (onboard monitoring OBM) is also possible. Thus, defects can be detected at an early stage and subsequently remedied, which in turn has a positive effect on the environmental friendliness and the intrinsic value of the vehicles operated in this way.

It is particularly advantageous that in the context of the invention the best possible operating condition of the vehicle can be set, since hypothetical scenarios are not used, which must always assume unfavorable conditions in the sense of compliance with limit values, but regulation is carried out on the basis of a situation that actually occurs in each case. The regulation of the filter efficiency on the basis of current particulate emissions can be reacted to as required, so that compliance with legally prescribed limit values is ensured at all times without having to permanently set unfavorable operating conditions.

Preferably, the measurement is carried out according to the valid PMP standards (Particle Measurement Programme) of the UN/ECE or according to comparable standards or based thereon. If necessary, these can be suitably adapted for a measurement in the exhaust system of the vehicle. On the basis of this measurement variable and other variables (for example driving speed, exhaust mass flow or volumetric flow), compliance with the particulate emission limits can be monitored at any time, for example in the control unit, or compliance with them can be considered in a forecast, in particular based on a model.

Usually, the emission limits refer to the driving distance, which in the case of a limit value for the particle number concentration results in the dimension of an inverse length or a unit of 1/km. Such concentrations related to the distance covered thus represent an average of the instantaneous emissions in a driving cycle.

Within any driving cycle, the instantaneous values of the emissions scatter between “infinity” (stationary vehicle) and “0” (rolling vehicle with stationary engine). Even if only the engine emissions (for example, in relation to the exhaust volume) are considered without taking into account the fluctuating driving speed, there is a very large scatter of the particulate emissions over multiple orders of magnitude.

It is therefore useful and advantageous to filter or smooth the current particulate emissions appropriately in order to be able to determine evidence or trend evidence for a driving cycle. Preferably, legal requirements are used for this purpose, which are necessary for the expected introduction of OBM. Minimum requirements for a driving cycle could, for example, define a minimum driving distance of a few km, which is a useful reference variable for the determination of overall emissions.

In addition to the consideration of driving cycles—and thus a comparatively very sluggish parameter as a result of this filtering—it is advantageous to use a dynamic additional variable for the control. On the basis of an engine raw emissions model (for example as a function of revolution rate, load, engine temperature, etc.), the instantaneous value of the filter efficiency can be determined at any time by comparison with the measured particle concentration, for example. By comparison with a setpoint for the filtration efficiency, which can either be fixed or determined dynamically/adaptively, the control of the system intervention towards “more loading=more efficiency” or towards regeneration of the filter is possible at any time.

Especially with the petrol engine, in which a very high proportion of particulate emissions can occur during a cold start, a forecast calculation is advantageous. Measured against the current or future criteria which define a valid driving cycle, the observation period or forecast period (driving distance) for which the average legally determined emission limit applies is determined. As a result of the high emissions after a cold start, early intervention is of particular importance in order to ensure compliance with the emissions limit values over the driving cycle which are to be assessed. In doing so, further variables which have a significant influence on the particulate emissions should preferably be taken into account.

This can be done, for example, with a model-based pilot control. An example for this is the consideration of the season and/or the temperature because the engine temperature during a cold start is a significant parameter for particulate emissions. Thus, in the presence of low outside temperatures, a higher degree of loading and thus a higher filtration efficiency and lower particulate emissions can be set as a setpoint or threshold value even with a warm engine in order to provide the necessary filter efficiency for the following cold start. The relevant outside temperature can be determined for example from the current temperature, from the last driving cycle, from the strongly filtered outside temperature, from data from an external signal (for example the cloud, weather forecast), etc.

A major influencing factor for the particulate emissions behavior of the petrol engine is the fuel quality. It should be noted that depending on the setting of the engine, for example with regard to the injection quantity, the ignition timing, etc., various fuels (for example petrol corresponds to the standard petrol with an octane number of 95, 98 or 100) provide the best emissions behavior in each case. For example, refueling with a fuel that is unfavorable in terms of particulate raw emissions (i.e. upstream of the particle filter) also leads to increased particulate emissions downstream of the particle filter. By means of the measurement or observation or detection of the particulate emissions, a deviation from a target or threshold value can be detected and a new higher loading state of the filter with consequently increased filtration efficiency can be regulated in the engine control. Such an increased loading setpoint over a driving cycle can subsequently be used to initially assume a high loading setpoint in a subsequent driving cycle. If the actual emissions behavior then turns out to be lower than expected, the model can be adjusted accordingly and the loading setpoint can be corrected downwards. In this way, compliance with the relevant limit values is ensured at the beginning of each journey and yet overall efficient operation is possible. Slowly changing parameters, such as fuel quality, are therefore slowly incorporated into the control of the filter loading, in particular into a pilot control, while a dynamic variable such as the current driving behavior is taken into account directly.

The overall system is therefore able to adapt to the current conditions in an optimal sense. In particular, AI approaches (artificial intelligence) or self-learning algorithms which take into account the individual driving history of a vehicle are promising and usable for adaptation. Depending on the implementation, this may also include taking into account the driving behavior of the vehicle user.

In such a case, a driver with an unfavorable driving style initially causes higher emissions. These are detected by the system and immediately compensated by the necessary compensation (higher filter loading) so that the emission limits are met. Without the invention, a violation of the emission limit values can be assumed. Otherwise, taking into account a driver with extremely unfavorable driving behavior would force always excessively high CO₂ emissions and high fuel consumption in order to be able to comply with the emission limits in any case.

A particularly favorable driving behavior of the user with consequently low particulate emissions leads to a lower loading condition of the filter with the result that particularly low CO₂ emissions and low fuel consumption are achieved. This advantage does not exist without the present invention.

In addition to the intervention of the loading control, further intervention options are advantageously provided to exclude imminently exceeding the emission limits, in particular based on the forecast calculation during a cold start. Temporary restrictions on the possible load change (dynamics) or a limitation of the operational map are possible, for example.

Both in the petrol engine and in the diesel engine, a dynamic assessment of the degree of regeneration achieved can be carried out by measuring the particulate emissions during an active regeneration of the filter. The complete regeneration of the filter can be avoided by a targeted termination of the active regeneration. Consequently, the critical phase immediately after particle filter regeneration with high emissions and/or low filtration efficiency due to a lack of filter cake can be avoided.

An important advantage of this invention is also that in the future changing legal provisions can be implemented in the form of a simple software update very efficiently in the entire existing vehicle fleet, since only the, in particular maximum permissible, threshold values or setpoints for the particulate emissions downstream of the particle filter must be adjusted. In conventional vehicle systems, on the other hand, extensive analyses and tests would have to be carried out separately for each vehicle type in order to be able to provide correspondingly updated control parameters.

If the particle sensor in the system can detect not only the total particulate emissions, but also the particle size distribution, further advantages are possible and usable.

Based on the measured particle size distribution, a comparison with the overall expected particle size distribution can be made as well as selectively in selected ranges of particle size. As already described, it can be assumed that due to the physical mode of action of the filter
in particular in combination with the emissions behavior of the engine in the system—there are size ranges in which the correlation with the target size and/or the loading state of the particle filter is particularly good and robust.

In the presence of such a correlation, an improved function of the invention may be possible. Particularly advantageous is the measurement of the particulate emissions in a size range in which a comparatively low filtration efficiency is present, which therefore reacts particularly sensitively to the loading.

In addition, further information about the loading state can be derived from the ratios of the particle concentrations of different particle sizes to each other. For example, corrections can be made in the engine control from the ratios—adapted to the respective emissions behavior of the system—in a targeted manner via the intervention variables. The type of the intervention variables for loading control is unchanged for this extended functionality. Depending on the current particle size distribution, for example, the intervention variables which are suitable for reducing the currently most relevant particle size fraction most effectively can be used to control the loading.

In particular, the observation of the regeneration state during a particle filter regeneration is particularly possible using the measured particle size distribution.

Preferably, in addition to the particle concentration downstream of the particle filter, the particle concentration upstream of the particle filter, in particular the particle concentration immediately downstream of the combustion engine, i.e. the raw emissions of the engine, will be measured.

As a result of a direct measurement of the raw emissions of the engine, the particle input into the filter is known at all times. Consequently, this signal can be used, among other things, for upstream control, especially if deviations from the expected particulate emissions occur. With the help of such an additional sensor, therefore, both the certainty that emission limits are not violated and the accuracy with which the loading state can be controlled can be increased.

With an additional sensor, therefore, the development of and data entry for an engine raw emissions model can be dispensed with, at least with regard to a dynamic measurement of the filter efficiency.

A computing unit according to the invention, for example a control unit of a motor vehicle, is, in particular programmatically, set up to carry out a method according to the invention.

Also the implementation of a method according to the invention in the form of a computer program or computer program product with program code for carrying out all steps of the method is advantageous, since this causes particularly low costs, in particular if an executing control unit is still used for further tasks and therefore is already present. Suitable media for the provision of the computer program are in particular magnetic, optical and electrical memories, such as hard disks, flash memory, EEPROMs, DVDs, etc. It is also possible to download a program over computer networks (Internet, Intranet, etc.).

### BRIEF DESCRIPTION OF THE DRAWINGS

Further advantages and embodiments of the invention result from the description and the enclosed drawing.

The invention is represented in the drawing based on an exemplary embodiment and is described below with reference to the drawing.

FIG. 1 shows a vehicle, which is set up to carry out an advantageous design of a method according to the invention, in the form of a greatly simplified block diagram.

FIG. 2 shows an advantageous embodiment of a method according to the invention in the form of a simplified flowchart.

### DETAILED DESCRIPTION

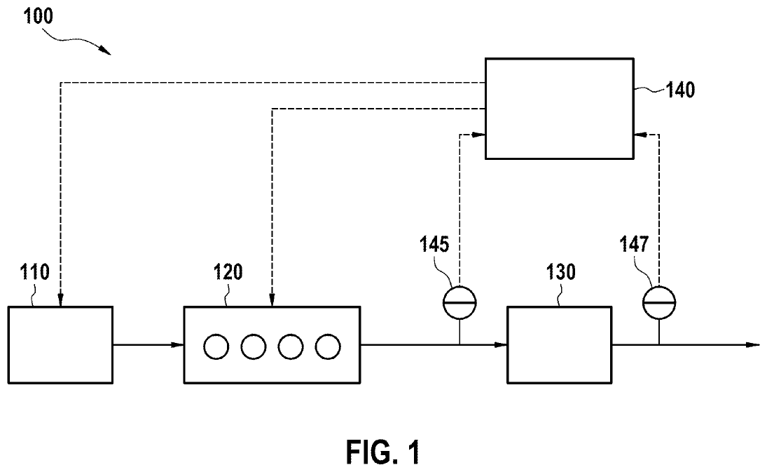

In FIG. 1, a vehicle 100, which is set up to carry out an advantageous design of a method according to the invention, is shown. The vehicle 100 comprises a combustion engine 120, a fuel preparation device 110, a particle filter 130, a control unit 140 and a first particle sensor 145 arranged upstream of the particle filter in an exhaust system of the vehicle 100 and a second particle sensor 147 downstream of the particle filter.

The first particle sensor 145 and the second particle sensor 147 are connected in a data-conducting or date-transmitting manner to the control unit 140, which in turn is connected to the combustion engine 120 and the fuel preparation device 110 in a data-conducting manner.

The fuel preparation device 110, which includes, for example, a turbocharger for compressing air, a fuel pump and an injection pump, is set up to supply the combustion engine with an air-fuel mixture and to adjust its composition and quantity depending on the signals received from the control unit 140.

The combustion engine 120, which comprises, for example, a petrol or diesel engine, is designed to burn the air-fuel mixture provided by the fuel preparation device 110 and thereby convert at least part of the released combustion enthalpy into mechanical work. The resulting exhaust gas is emitted by the combustion engine 120 into the exhaust system of the vehicle 100, so that the exhaust gas flows through the particle filter 130 on its way into an atmosphere surrounding the vehicle 100.

The particle filter 130 is set up to retain particulate components of the exhaust gas at least partially, so that the exhaust gas leaving the particle filter 130 is depleted of the particulate components in the particle filter compared to the exhaust gas entering the particle filter 130. The particle filter 130 comprises, for example, a suitable filter material, for example a porous material of ceramic or metallic type for this purpose. Such filter materials retain the particulate components of the exhaust gas by the particles interacting mechanically with the filter material, in particular by colliding. In connection with such a mechanical interaction and/or alternatively thereto, adhesion forces may occur (for example electrostatic or chemical bonds, in particular van der Waals forces) which prevent particles from being further transported through the filter material once in the filter.

In principle, all known devices for the detection of particles in a fluid flow can be considered as particle sensors. For example, such particle sensors work on the basis of scattered light, light extinction or laser diffraction. Also sensors which are based on laser-induced or light-induced incandescence (LII), condensation particle counting (CPC) or high-voltage processes (escaping current, electrostatic method), can be used for this purpose. However high voltage methods cannot measure PN directly. In such cases, the measurement signal can be converted into the particle number PN by means of a raw emissions model.

In some embodiments of the particle filter 130, electrodes for retaining the particulate exhaust gas components may also be provided. In such systems, particles present in the exhaust gas are pushed towards the electrodes by electrostatic and/or electrodynamic interactions and deposited there. In such electrostatic precipitators, the particle size distribution of the separated particles can be influenced by changing the potential applied to the electrodes.

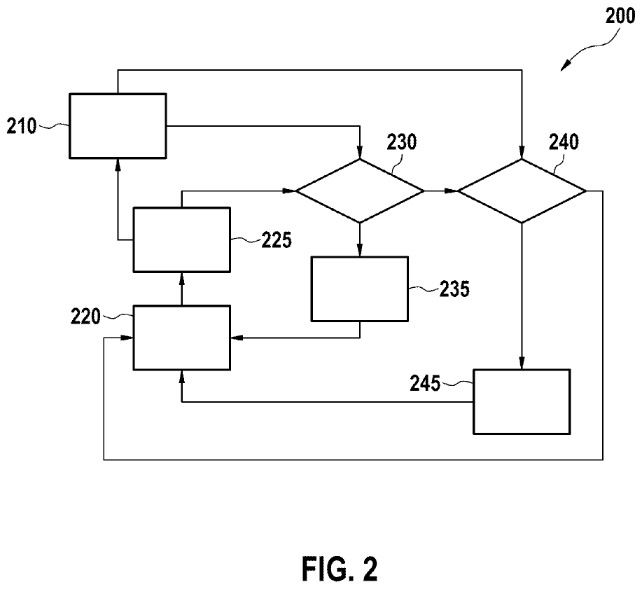

FIG. 2 illustrates a method 200 which is used to control the loading of a particle filter 130. In a parameterization step 210, a first threshold value in the form of a maximum particle concentration, which is not to be exceeded downstream of the particle filter 130, and a second threshold value in the form of a minimum particle concentration, which is not to be undercut downstream of the particle filter, are determined. The first and second threshold values can also be the same and in this sense form a setpoint for the control. In a measuring step 220, a particle concentration downstream of the particle filter 130 is measured. In particular, the second particle sensor 147 arranged downstream of the particle filter 130 can be used for this purpose.

The measured value of the particle concentration is transmitted to the control device and can be stored there in a step 225, in particular together with other variables, for example a current load requirement, a current engine temperature, a current outside temperature, the time of day and/or season, the weather and the like.

In a comparison step 230, it is checked whether the measured particle concentration is below the minimum concentration. If this is the case, a control step 235 causes the exhaust gas flow upstream of the particle filter 130 to experience an increase in the proportion of oxidizing components. In addition, the fuel preparation device 110 can be controlled by means of the control unit in such a way that the composition of the air-fuel mixture is changed in favor of air or at the expense of fuel. As a result, the exhaust gas mixture downstream of the combustion engine 120 becomes leaner and more residual oxygen or other oxidizing compounds are available, which oxidize some of the particles deposited in the particle filter 130 and thus remove them from the particle filter 130. In other words, a filter cake in the particle filter 130 is burned off in this way at least partially. This reduces the back pressure of the exhaust system against which the combustion engine 120 must work, which increases the usable degree of effectiveness of the combustion engine 120.

If, on the other hand, it is determined in the comparison step 230 that the particle concentration does not exceed the second threshold value, it is checked in a further step 240 whether the maximum particle concentration is exceeded. If this is the case, in a control step 245 influencing of the exhaust gas composition follows in such a way that fewer oxidizing components are permitted. For this purpose, for example, the composition of the air-fuel mixture provided by the fuel preparation device 110 can be changed in favor of fuel or at the expense of air. Another possibility is control of the combustion engine 120, for example to change ignition timings. As a result, for example, it can be achieved that the combustion of the air-fuel mixture is more complete or less complete. In addition, the exhaust gas temperature can be influenced in this way. Overall, intervention in the control of the combustion engine 120 and/or the fuel preparation device 110 is carried out in such a way that the filter cake is built up in the particle filter 130, the loading of the particle filter 130 thus increases, if the first threshold value is exceeded.

If, on the other hand, the first threshold value is not exceeded, the method 200 returns to the measurement step 220.

It is understood that certain steps can be swapped with each other or combined into a common step without changing the way the method 200 works. For example, the two comparison steps 230 and 240 can be swapped with each other or combined into a single comparison step, just as the two control steps 235 and 245 can be combined into a single control step if the associated comparison steps are carried out together.

The data stored in step 225 can be used to determine the minimum and/or maximum particle concentration. For example, the minimum particle concentration can be increased if only a few particles are measured downstream of the particle filter 130 over a longer period of time in order to reduce the filter efficiency and thus positively influence the consumption behavior of the combustion engine 120. If, on the other hand, a high particle concentration is detected downstream of the particle filter 130 over a longer period of time, it can be assumed that some influencing factors are in an unfavorable range and therefore greatly increased particulate emissions are to be expected in the future, for example after a break in operation in which the engine temperature drops. In such a situation, it is advantageous if the filtration efficiency is increased as a precaution, for example to safely ensure compliance with legal requirements.

It may also be advantageous to lower the first threshold value when the second threshold value is increased. This is particularly useful if the first threshold value is very close to a legally prescribed limit value. If the second threshold value is increased, the filtration efficiency regularly decreases as a result, which can then lead to increased particulate emissions downstream of the particle filter 130 in the event of changing load requirements. In order to be able to safely comply with the legal limit values, a safety margin should therefore be provided in the case of a reduced filtration efficiency in order to increase the filtration efficiency in a timely manner if the particle concentration increases due to dynamic changes in the operating state of the combustion engine 120. The parameterization step 210 can therefore be designed in such a way that with increased fuel efficiency (less filter loading), the loading of the filter is rebuilt faster if necessary than with the filtration efficiency already set high (high filter loading).

Advantageously, a loading parameter can be calculated dynamically, which maps the current loading state of the filter and thus the expected filtration efficiency. In particular, a difference between particle concentrations measured upstream and downstream of the particle filter 130 can be included in this calculation of the loading parameter. If no particle sensor 145 is provided upstream of the particle filter 130, the calculation can also be made on a numerical model which, for example, uses data from the control unit to model a current particle concentration upstream of the particle filter 130. Further data, for example engine and/or outside temperatures, differential pressure across the particle filter, lambda values in the exhaust system and the like, can be included in the calculation of the loading parameter or in the modeling of the particle concentration upstream of the particle filter 130.

1. A method (200) for operating a combustion engine (120) with a particle filter (130), the method comprising:
passing an exhaust gas flow of the combustion engine (120) through the particle filter (130), measuring (220) a particle concentration in the exhaust gas flow downstream of the particle filter (130), and
operating the combustion engine based on the measured particle concentration downstream of the particle filter.

2. The method (200) according to claim 1, wherein the combustion engine (120) is operated in such a way that a loading of the particle filter (130) with particles increases (245) if the measured particle concentration exceeds a predetermined first threshold value (230) or that the loading of the particle filter decreases (235) if the measured particle concentration is below a second predetermined threshold value (240).

3. The method (200) according to claim 2, wherein the first threshold value and/or the second threshold value are determined as a function of at least one emission-relevant parameter (210) selected from group consisting of engine temperature, outside temperature, ambient pressure, composition of the atmosphere, season, fuel quality, aging, defects and driving behavior.

4. The method (200) according to claim 1, wherein the loading of the particle filter is adjusted by adjusting a composition of the exhaust gas flow upstream of the particle filter.

5. The method (200) according to claim 4, wherein the composition of the exhaust gas flow is shifted to the detriment of oxidizing components, if the measured particle concentration is above the first threshold value and/or is shifted in favor of the oxidizing components if the measured particle concentration is below the second threshold value.

6. The method (200) according to claim 1, further comprising measuring a particle concentration upstream of the particle filter.

7. The method (200) according to claim 1, wherein the particle concentration describes a number of particles and/or a particle mass, each based on a predeterminable exhaust gas volume or a predeterminable driving distance.

8. The method (200) according to claim 1, wherein at least one particle concentration is measured with respect to at least one range of a particle size distribution (220).

9. The method (200) according to claim 1, wherein the combustion engine comprises a machine with compression ignition and/or a machine with external ignition.

11. A non-transitory, computer-readable medium containing instructions that when executed by a computer cause the computer to control a combustion engine (120) with a particle filter (130) to
pass an exhaust gas flow of the combustion engine (120) through the particle filter (130),
measuring (220) a particle concentration in the exhaust gas flow downstream of the particle filter (130), and
operate the combustion engine based on the measured particle concentration downstream of the particle filter.
